(19) United States
(12) Patent Application Publication
(10) Pub. No.: US 2011/0072253 A1
(43) Pub. Date: Mar. 24, 2011

(54) METHOD, SYSTEM AND PROGRAM PRODUCT FOR DETERMINING AN OPTIMAL CONFIGURATION AND OPERATIONAL COSTS FOR IMPLEMENTING A CAPACITY MANAGEMENT SERVICE

(75) Inventors: Mickey Iqbal, Plano, TX (US); Frances F. Wand, Corning, NY (US)

(73) Assignee: INTERNATIONAL BUSINESS MACHINES CORPORATION, Armonk, NY (US)

(21) Appl. No.: 12/955,560

(22) Filed: Nov. 29, 2010

Related U.S. Application Data
(63) Continuation of application No. 11/567,406, filed on Dec. 6, 2006.

(51) Int. Cl. G06F 9/00

(52) U.S. Cl. 713/1

(57) ABSTRACT

A method, system and program product for determining an optimal configuration and operational costs for implementing a capacity management service. The method includes storing in a knowledge management system factual data and business rules for determining an optimal configuration for implementing the capacity management service, and inputting into the knowledge management system a plurality of business-technical variables supplied by an end user. The method further includes selecting a priority level for one or more of the business-technical variables inputted based on a set of business-technical factors, harmonizing the priority level selected for the one or more business-technical variables in order to minimize any inconsistencies among the priority level selected and determining the optimal configuration and associated operational costs for implementing the capacity management service, using the business-technical variables inputted and using the factual data and the business rules stored in the knowledge management system.

### FIELD OF THE INVENTION

The present invention relates to a method, system and computer program product for determining an optimal configuration and operational costs for executing an application or operating a business. In particular, the present invention relates to a method, system and computer program product for developing or determining an optimal configuration and operational costs for implementing a capacity management service plan or proposal for executing an application or operating a business.

### BACKGROUND OF THE INVENTION

In today's business environment, an organization and/or business utilizes capacity planning to deploy a business plan or operation. Often, organizations have to invest considerable resources to deploy a business plan or operation and also for managing or maintaining the business operation and, as such, want to ensure that any infrastructure employed to deploy the business plan or operation is used in the most efficient manner. A reasonably accurate up-front estimate of the business plan or operation costs can provide an organization and/or business with a competitive advantage in the proposal development and approval process, and also prevent costly price overruns and implementation delays. As such, there is a need for an efficient way to deploy a business plan and to provide a reasonable estimate for deploying the business plan, given the different choices available for performing various tasks for deploying the business plan.

### SUMMARY OF THE INVENTION

In a first aspect of the invention, there is provided a method of determining an optimal configuration and operational costs for implementing a capacity management service. The method includes storing in a knowledge management system factual data and business rules for determining an optimal configuration for implementing a capacity management service, and inputting into the knowledge management system a plurality of business-technical variables, the plurality of business-technical variables being supplied by an end user. The method further includes selecting a priority level for one or more of the plurality of business-technical variables inputted based on a set of business-technical factors, harmonizing the priority level selected for the one or more of the plurality of business-technical variables in order to minimize any inconsistencies among the priority level selected for the one or more of the plurality of business-technical variables and determining the optimal configuration and associated operational costs for implementing the capacity management service, using the plurality of business-technical variables inputted, and using the factual data and the business rules stored in the knowledge management system. In an embodiment, the method further includes reporting the optimal configuration and the associated operational costs determined to the end user. In an embodiment, the determining step further includes updating the factual data and the business rules stored in the knowledge management system, modifying any of the plurality of business-technical variables inputted and deciding a priority level for the any of the plurality of business-technical variables modified. In an embodiment, the determining step further includes analyzing, using a decision and sensitivity analysis tool, the optimal configuration based on the plurality of business-technical variables inputted by the end user and based on the factual data and the business rules stored in the knowledge management system and automating adjustment of the priority level selected for the any of the plurality of business-technical variables modified in order to minimize any inconsistencies among the plurality of business-technical variables. In an embodiment, the determining step further includes loading the plurality of business-technical variables inputted, the factual data and the business rules stored in the knowledge management system into a cost analysis modeling tool for determining the associated operational costs for the optimal configuration determined. In an embodiment, the determining step further includes re-determining an alternate optimal configuration and alternate associated operational costs for implementing the capacity management service based on any updated factual data and business rules and based on any of the plurality of business-technical variables modified. In an embodiment, the set of business-technical factors for establishing the priority level includes at least one of cost, performance, network bandwidth, length of equipment lease streams, license costs, transaction volumes for each application, input/output requirements, CPU and processing requirements, floor space requirements, power requirements, server consolidation requirements, and ability to effectively execute an application. In an embodiment, the plurality of business-technical variables includes at least one of current server CPU, current memory, current disk storage, current network interface configuration, current test environment, current production environment, minimal server CPU, optimal server CPU, minimal memory, optimal memory, minimal disk storage, optimal disk storage, minimal network interface configuration, optimal network interface configuration, application software configuration on a server, middleware package configuration on the server, system software configuration on the server, version, release and license type for operating system on the server, version, release and license type for each application software package, version, release and license type for each middleware package, version, release and license type for each system software package anticipated application usage peak hours, anticipated application usage peak days, anticipated application usage special pattern, anticipated application usage peak to average ratio of application usage, criticality of application, population of users, location of users, type of network connection used by users to access the application, anticipated growth of application usage at different times, location of data center where server will be placed, type of service offerings to be used, type of infrastructure models that application will use, desired date that infrastructure needs to be in production, and desired formats for reports.

In another aspect of the invention, there is provided a system for determining an optimal configuration with corresponding operational costs for implementing a capacity management service. The system includes a capacity management services (CMS) costing tool that includes a user interface component configured to receive a plurality of business-technical input data from an end user, one or more of the plurality of business-technical input data being assigned by the end user a priority level based on a set of business-technical factors, a knowledge management system component configured to store factual data and business rules associated with determining an optimal configuration for implementing a capacity management service, the knowledge management system component being configured to store the plurality of business-technical input data received from the end user, a decision and sensitivity analysis component configured to determine the optimal configuration for implementing a capacity management service based on the factual data and the business rules stored and based on the priority level set by the end user for the one or more business-technical input data and a cost analysis modeling component configured to calculate corresponding operational costs for the optimal configuration determined for implementing the capacity management service, using the factual data and the business rules stored in the knowledge management system and by using the plurality of business-technical input data received from the end user, wherein the capacity management services costing tool is configured to provide a controlled and a secure programming interface between each of the user interface component, the knowledge management system component, the decision and sensitivity analysis component, the cost analysis modeling component and one or more external systems. In an embodiment, the decision and sensitivity analysis component is further configured to utilize an assumption based truth maintenance system for determining the optimal configuration for implementing the capacity management service. In an embodiment, the decision and sensitivity analysis component is further configured to identify criticality for the priority level assigned to the one or more of the plurality of business-technical input data by the end user based on the set of business-technical factors and is configured to adjust the priority level for the one or more of the plurality of business-technical input data in order to minimize any inconsistencies among the business-technical input data for determining the optimal configuration and the corresponding operational costs for implementing the capacity management service. In an embodiment, the knowledge management system is further configured to receive updates for the plurality of business-technical input data and for the factual data and the business rules stored therein. In an embodiment, the cost analysis modeling component is further configured to calculate the corresponding operational costs using functions and formulas that calculate transition costs and steady state costs associated with the optimal configuration for implementing the capacity management service. In an embodiment, the plurality of business-technical input data includes at least one of current server CPU, current memory, current disk storage, current network interface configuration, current test environment, current production environment, minimal server CPU, optimal server CPU, minimal memory, optimal memory, minimal disk storage, optimal disk storage, minimal network interface configuration, optimal network interface configuration, application software configuration on a server, middleware package configuration on the server, system software configuration on the server, version, release and license type for operating system on the server, version, release and license type for each application software package, version, release and license type for each middleware package, version, release and license type for each system software package, anticipated application usage peak hours, anticipated application usage peak days, anticipated application usage special pattern, anticipated application usage peak to average ratio of application usage, criticality of application, population of users, location of users, type of network connection used by users to access the application, anticipated growth of application usage at different times, location of data center where server will be placed, type of service offerings to be used, type of infrastructure models that application will use, desired date that infrastructure needs to be in production, and desired formats for reports and wherein the set of business-technical factors for establishing the priority level includes at least one of cost, performance, network bandwidth, length of equipment lease streams, license costs, transaction volumes for each application, input/output requirements, CPU and processing requirements, floor space requirements, power requirements, server consolidation requirements, and ability to effectively execute an application.

In yet another aspect of the invention, there is provided a computer program product for determining an optimal configuration and associated operational costs for implementing a capacity management service. The computer program product includes a computer readable medium, first program instructions to store input data into an expert system, the input data including a plurality of business-technical variables, factual data and business rules and second program instructions to assign a priority rating for one or more of the plurality of business-technical variables based on a set of business-technical factors. The computer program product further includes third program instructions to determine an optimal configuration for implementing a capacity management service based on the input data stored and to determine associated operational costs for the optimal configuration determined based on the input data stored. In an embodiment, the computer program product further includes fourth program instructions to provide reports to an end user detailing the optimal configuration and the associated operational costs determined for implementing the capacity management service. In an embodiment, the first program instructions include instructions to update factual data and business rules stored in the expert system and wherein the first program instructions include instructions to update one or more of the plurality of business-technical variables stored in the expert system. In an embodiment, the second program instructions include instructions to harmonize the priority rating assigned for the one or more of the plurality of business-technical variables in order to minimize any inconsistencies among the priority rating assigned for the one or more of the plurality of business-technical variables. In an embodiment, the third program instructions include instructions to re-determine an alternate optimal configuration and to re-calculate alternate operational costs for implementing the capacity management service based on any updated factual data and business rules and based on any harmonization of the priority rating for the one or more of the plurality of business-technical variables. In an embodiment, the plurality of business-technical input data includes at least one of current server CPU, current memory, current disk storage, current network interface configuration, current test environment, current production environment, minimal server CPU, optimal server CPU, minimal memory, optimal memory, minimal disk storage, optimal disk storage, minimal network interface configuration, optimal network interface configuration, application software configuration on a server, middleware package configuration on the server, system software configuration on the server, version, release and license type for operating system on the server, version, release and license type for each application software package, version, release and license type for each middleware package, version, release and license type for each system software package, anticipated application usage peak hours, anticipated application usage peak days, anticipated application usage special pattern, anticipated application usage peak to average ratio of application usage, criticality of application, population of users, location of users, type of network connection used by users to access the application, anticipated growth of application usage at different times, location of data center where server will be placed, type of service offerings to be used, type of infrastructure models that application will use, desired date that infrastructure needs to be in production, and desired formats for reports and wherein the set of business-technical factors for establishing the priority level includes at least one of cost, performance, network bandwidth, length of equipment lease streams, license costs, transaction volumes for each application, input/output requirements, CPU and processing requirements, floor space requirements, power requirements, server consolidation requirements, and ability to effectively execute an application. In an embodiment, each of the first, second, third and fourth program instructions are stored on the computer readable medium.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a flowchart which outlines the process of inputting and/or entering data into a knowledge management system, which stores the data inputted and/or entered, in accordance with an embodiment of the present invention.

FIG. 2 depicts a flowchart which outlines the steps involved in determining an optimal configuration and the associated operational costs for implementing a capacity management service, in accordance with an embodiment of the present invention.

FIG. 3 depicts a Capacity Management Services (CMS) costing tool for determining an optimal configuration and the corresponding operational costs for implementing a capacity management service, in accordance with an embodiment of the present invention.

FIG. 4 is a schematic block system diagram illustrating an embodiment of a computer infrastructure for determining an optimal configuration and the corresponding operational costs for implementing a capacity management service, in accordance with an embodiment of the present invention.

### BEST MODE FOR CARRYING OUT THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

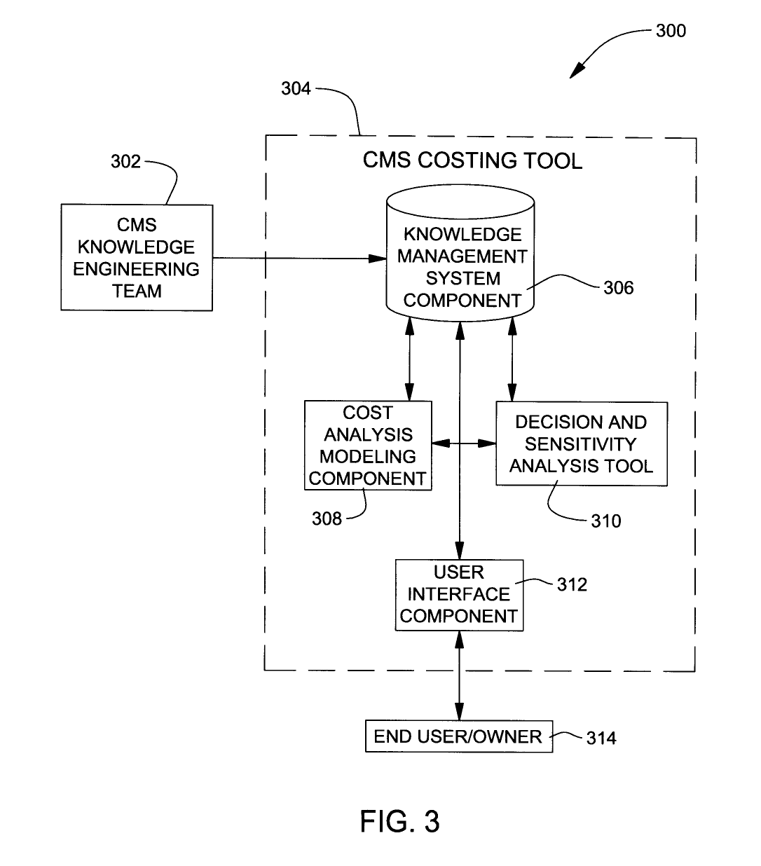

In one embodiment, the invention provides a method of determining an optimal configuration and associated operational costs for implementing a capacity management service. In an embodiment, the method is a computer based method for determining an optimal configuration as well as associated operational costs for implementing a capacity management service for executing an application. As used herein, the phrase “executing an application” can refer to the deployment of any number of software applications (which may include several components) for carrying out a business purpose, such as operating a data call center, or can refer to the execution of a business plan, for example, taking over operations of a data call center. Further, as used herein, the phrase “implementing a capacity management service” refers to the use of a Capacity Management Services costing tool (or referred to as CMS costing tool, which is described further herein below with respect to FIG. 3) for determining an optimal configuration for implementing a capacity management service for executing an application or operating a business. Capacity Management Service or Services (or CMS) refers to a system of comprehensive services for sizing and forecasting an information technology (IT) infrastructure hardware configuration, using a CMS costing tool that determines the IT infrastructure or configuration taking into account other factors, such as, human resources (labor), business processes and facilities, to ensure that the IT infrastructure is used in the most efficient manner. In an embodiment, the invention provides a computer based method, using a Capacity Management Services (CMS) costing tool, for determining an optimal configuration for implementing a capacity management service as well as providing a reasonably accurate estimate for implementing the capacity management service based on a plurality of required technical variables and business variables (referred to herein as business-technical variables) that are supplied by an organization or business or a person (herein referred to as the “owner” or “end user”) considering a capacity management service (CMS) solution.

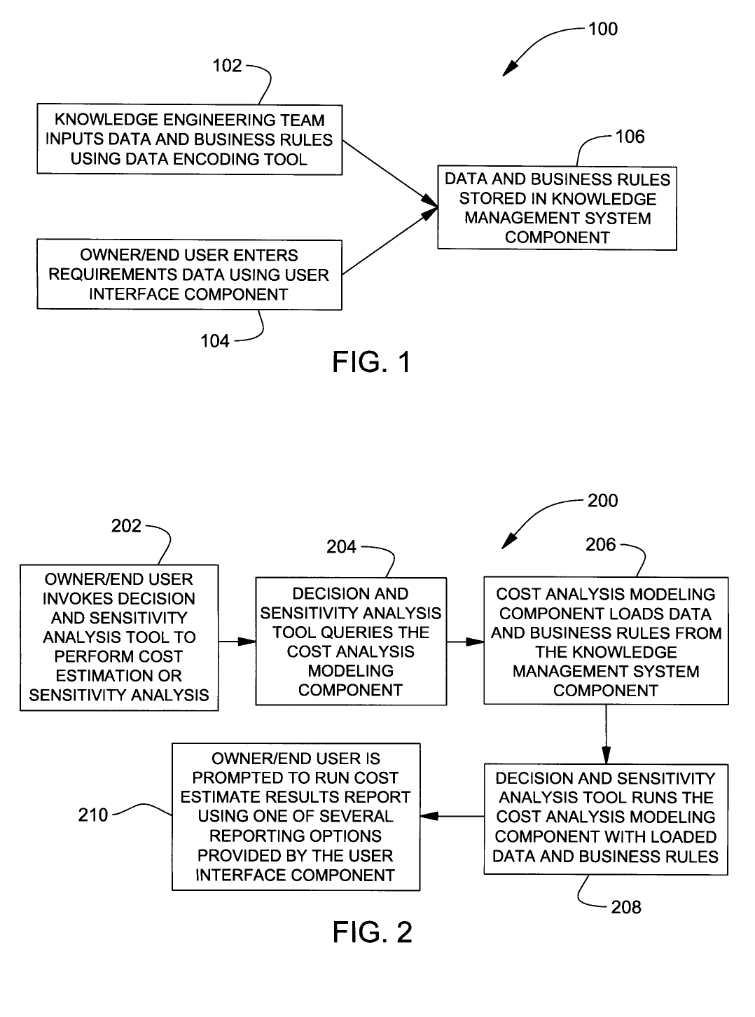

Reference is now made to FIGS. 1 and 2, which together illustrate a method of determining an optimal configuration and associated operational costs for implementing a capacity management service (CMS). Turning to FIG. 1, reference numeral 100 illustrates a method of providing a knowledge management component or an expert system that stores relevant facts and/or data (often referred to herein as factual data) needed for determining an optimal configuration and associated operational costs for implementing a capacity management service, in accordance with an embodiment of the invention. As shown in the flowchart 100, a Capacity Management Services (CMS) knowledge engineering team (referred to herein as simply knowledge engineering team or CMS knowledge engineering team), inputs or enters in step 102 relevant factual data and business rules into a knowledge management system or knowledge repository. As used herein, a “business rule” is any rule that is used or applied in a given situation, such as, return a leased equipment or server to vendor when the lease expires or increase a server's CPU by a certain amount or percentage if the server is consistently operating at 85% peak levels, etc. Accordingly, all the relevant factual data and business rules relevant for determining an optimal configuration for implementing a capacity management service are stored in step 106 in the knowledge management system component. The CMS knowledge engineering team, are domain experts with respect to the different data stored in the knowledge management system or knowledge repository. The knowledge management system component provides an integrated knowledge repository, which stores facts, business rules, and data pertaining to all related knowledge domains, historical measurements data from previous similar operational efforts, and also includes facts and business rules related to expertise in the utilization of any given combination of components (hardware, software, facilities, etc.) for determining or creating an optimal configuration. In an embodiment, the knowledge management system component also contains a data processing engine which performs data management operations on the data stored within the repository. In an embodiment, the knowledge management system component stores facts and/or data, for example, hardware lease cost of hardware manufactured by a vendor per month over a lease lifetime, length of hardware lease for a particular storage device in number of months, hardware maintenance cost per year for a particular server, monthly disk storage charge per supplier, network per port charge for port of a certain size, effort required (in hours) to collect and analyze server statistics with medium complexity by worker of intermediate skill level, effort required (in hours) to collect and analyze server statistics with medium complexity by worker of expert skill level, CPU and speed required by an application of a particular vendor, CMS tool-set A can provide server hardware platform/CPU configuration conversion based on the industry standard of CPU performance rating, CMS tool-set B can provide statistics of the application CPU, memory, disk storage usage, network I/O and current configuration, software vendor's application package series K are not certified on hardware Vendor H series servers, data centers at locations A and B are capable of supporting high density server platforms, such as blade centers, and the structure support and cooling specifications allows the data centers to host shark storage servers, data centers at locations C and D, can only support the servers able to going into rack type X with at most Y height, shared SAN storage, etc. Similarly, the knowledge management system contains business rules, which are encoded within the knowledge management system using a computer programming language which facilitates the computer based representation of business rules and their processing by a data management engine within the knowledge management database component.

Accordingly, as shown in FIG. 1, the knowledge engineering team feeds all the required data, facts and business rules into the knowledge repository using a data encoding tool. An update of the information (facts, data, business rules, etc.) stored in the knowledge database by the knowledge engineering team can be made on an as needed basis or at predefined periods in time. The updates can be made using an electronic file transfer over the network or using any type of electronic storage media (such as CD, DVD, floppy diskette, etc.). The periodic updates ensure the currency of the facts, data and business rules stored within the knowledge repository. Further, as shown in FIG. 1, an owner and/or end user enters requirements data, that is, a plurality of business-technical variables into the knowledge management system, using a user interface component of a Capacity Management Services (CMS) costing tool, as discussed further herein below with respect to FIG. 3. In an embodiment, the required technical and business variables for which the owner's input is solicited include, for example, current server CPU, memory, disk storage, and network interface configuration, if application is currently running in an existing environment (test or production environment to be relocated or to be updated); the minimum and optimal server CPU, memory, disk storage and network interface configuration requirements by the software developer/vendor, if the application is new; the anticipated application usage peak hours, peak days, or special usage pattern, what is the anticipated usage peak to average ratio of this application, how critical the application is to the business (providing a list of ratings), application software configuration on the server, including software package, version and release, and license type for the Operating System (OS), application software package, middleware package, system software packages, the characteristics of major application transaction types (such as CPU, memory, or disk I/O intensive or not), user population and their locations, type of network connection that a user will use to access the server, anticipated growth of the application usage with different time horizons, the location of the data center that the server is going to be placed in, the type of service offerings or infrastructure models that the application is going to use, the desired date that the server needs to be provisioned, or go into production, the desired formats for the report, etc. Further, the end user/owner selects or sets forth a priority rating or level for one or more of the business-technical variables supplied based on a set of business-technical factors, such as, cost, performance, network bandwidth, length of equipment lease streams, license costs, transaction volumes for each application, input/output requirements, CPU and processing requirements, floor space requirements, power requirements, server consolidation requirements, and ability to effectively execute an application. As shown in FIG. 1, the requirements data or business-technical variables entered by the end user or owner in step 104 is ultimately fed into the knowledge management system component, which is designed to accept the end user's or owner's set of requirements and to store the requirements in a data format, which in addition, can facilitate further processing of the data.

Turning to FIG. 2, reference numeral 200 describes the process for determining an optimal configuration and the associated operational costs for implementing a capacity management service, using the information (factual data and business rules) stored in the knowledge management system component and the plurality of business-technical variables (requirements data) inputted or entered by the end user/owner, as discussed with respect to FIG. 1. An owner and/or end user wanting to determine an optimal configuration, including the associated operational costs, enters the requirements data using a user interface component of a Capacity Management Services (CMS) costing tool (described further herein below with respect to FIG. 3), which invokes in step 202 a decision and sensitivity analysis tool or component of the Capacity Management Services (CMS) costing tool. Further, in an embodiment, the decision and sensitivity analysis component is configured to harmonize or automatically adjust the priority levels selected or set forth by the end user/owner for the one or more of the plurality of business-technical variables entered in order to minimize any inconsistencies among the priority level selected for the one or more of the plurality of business-technical variables. In an embodiment, the decision and sensitivity analysis component is configured to perform a sensitivity or what-if analysis for determining an optimal configuration as well as is configured to perform cost estimates for the optimal configuration proposed or determined for implementing the capacity management service. As such, the decision and sensitivity analysis component determines an optimal configuration for implementing the capacity management service by using and analyzing the plurality of business-technical variables inputted, and using and analyzing the factual data and the business rules stored in the knowledge management system. Further, the decision and sensitivity analysis tool or component queries in step 204 a cost analysis modeling component for performing a cost estimation analysis for determining the operational costs for the optimal configuration determined. In an embodiment, the cost analysis modeling component loads in step 206 the pre-stored factual data and business rules from the knowledge management system component in order to perform a cost estimation analysis for the optimal configuration proposed. In step 208, the decision and sensitivity analysis component or tool runs in step 208 the cost analysis modeling component with the loaded factual data and business rules. The loaded information is then evaluated and processed by different functions and formulas stored within the cost analysis modeling (described herein below with respect to FIG. 3), and the resulting cost estimates are fed back to the end user/owner via the user interface component. Accordingly, once the requirements data or information provided by the user/owner has been stored inside the knowledge management system component, the end user/owner can invoke the decision and sensitivity analysis tool to perform a cost analysis (or sensitivity/what-if analysis on a previously generated cost estimate after tweaking a few business-technical variables). Further, the optimal configuration determined as well as the resulting cost estimates are reported to the end user/owner. As shown in FIG. 2, the owner and/or end user is prompted in step 210 to run a cost estimate results report using one or several different reporting options provided by the user interface component of the Capacity Management Services (CMS) costing tool. In particular, once all requirements data has been input, the user interface can be used to generate various types of cost estimation proposal reports in various formats including screen based reports, HTML reports, PDF files, text file reports, CSV file based reports, etc. The reports include various cost accounts broken down by cost categories (hardware, software, labor, etc. for the life-cycle management of the capacity management service. The various types of reports are provided as a result of the inputs fed into the Capacity Management Services (CMS) costing tool and the back-end processing performed by other components described in detail further below. The cost data can also be reported in a granular format with reporting categories, such as hardware types, hardware configurations, refresh cycles, application types, deployment costs, on-going steady state costs, overall costs, etc.

Accordingly, using the knowledge management system component or expert systems, the right or optimal configuration for implementing a capacity management service and its costs becomes available right after the owner finishes inputting the data. As an owner tunes or adjusts the priority ratings on various requirements data, the CMS costing tool re-determines or re-generates an alternate optimal configuration with different options and re-calculates a set of alternate operational costs associated with the alternate optimal configuration. Thus, the method provides an end user/owner proposal options with different perspectives, enabling the end user/owner to make better informed decisions. Further, the above method can leverage historical data, for instance, on a previous decision regarding implementing a capacity management service, for follow-up analysis (such as, renewing a contract) that incorporates new data to perform a comprehensive analysis. Moreover, the method is applicable with new technologies, newly developed rules and new data as they become available and input into the CMS costing tool. As such, the interdependencies among infrastructure, facility, business and application are readily identified and associated seamlessly and in parallel. This allows end users/owners to prioritize the requirements for an application or operation as a situation changes or to approach the problem with different perspectives. Moreover, given that the CMS costing tool solicits requirements data with priority levels or ratings that are selected by an end user/owner, such as ratings on the importance of meeting the go-live date, ratings on the importance of the proximity to the application end users, and ratings on the complexity involved supporting the application on a virtualized environment, etc., the CMS costing tool can provide a specific solution or proposal that is based on any priority levels or ratings for the requirements data set by the end user/owner. If the priority levels or ratings are adjusted, the CMS costing tool will recalculate and provide an alternate optimal configuration for implementing the capacity management service based on the new or modified priority ratings.

In another embodiment, the invention provides a system for determining an optimal configuration with corresponding operational costs for implementing a capacity management service. Reference is now made to FIG. 3, reference numeral 300 depicts a system 300 for determining an optimal configuration with corresponding operational costs for implementing a capacity management service, in accordance with an embodiment of the invention. Turning to FIG. 3, the system 300, in an embodiment, is a multi-tier computer architecture, which includes a Capacity Management Services (CMS) costing tool 304. The CMS costing tool 304 comprises a knowledge management or expert system component 306, a cost analysis modeling component 308, a decision and sensitivity analysis tool or component 310 and a user interface component 312. The CMS costing tool 304 provides a controlled and a secure programming interface between each of the user interface component 312, the knowledge management system component 306, the decision and sensitivity analysis component 310, the cost analysis modeling component 308 and one or more external systems. As shown in FIG. 3, the knowledge management system component 306 is configured to receive input (factual data and business rules) from the CMS knowledge engineering team 302, as described herein above with respect to FIG. 1. Further, the knowledge management system component 306 is configured to receive updates for the factual data and/or business rules from the CMS knowledge engineering team. Moreover, the knowledge management system component 306 is configured to receive input from the end user and/or owner 314 via the user interface component 312. Further, each of the cost analysis modeling component 308 and the decision and sensitivity analysis component 310 can access the knowledge management system component 306. In particular, the information stored in the knowledge management system component 306 can be loaded into the decision and sensitivity analysis component 310 in order to develop or generate an optimal configuration for implementing a capacity management service. Similarly, the information stored in the knowledge management system component 306 can be loaded into the cost analysis modeling component 308 in order to calculate operational costs corresponding to the optimal configuration developed or determined by the decision and sensitivity analysis component 310.

In an embodiment, the user interface component 312 is configured to elicit and capture requirements data or information from the owner/end user about technical variables and/or business variables (business-technical variables or input data) in order to implement a capacity management service. This information includes details about the end user's and/or owner's technical and business requirements data (as per the examples described herein above) that the infrastructure hardware configuration will need to meet. The information gathered from the owner/end user can be based on either the owner's precise knowledge or the best guess knowledge or estimation of the requirements for implementing the capacity management service. Further, the user interface component 312 provides the owner and/or end user with guidance (system generated user help and variable selection recommendations) in selecting the various alternative input parameters for the business and technical variables that will have an impact on the optimal configuration being determined or developed as well as the corresponding operational costs for implementing the capacity management service. The CMS costing tool 304 captures the owner's or end user's requirements via the business-technical input data or variables inputted into the CMS costing tool 304 and allows an owner and/or end user 314 to select or assign priority levels or ratings for one or more of the business-technical input data or variables based on a set of business-technical factors (as mentioned herein above), and further, the user interface component 312 also conveys any processed cost estimates performed by the cost analysis modeling component 308 (run by the decision and sensitivity analysis component 310), back to the end user 314. In an embodiment, the decision and sensitivity analysis component 310 of the CMS costing tool 304 is configured to identify criticality for a priority level assigned by an end user/owner to one or more business-technical input data and is configured to automatically adjust the priority level assigned by an end user/owner to minimize inconsistencies among the business-technical variables or input data. Further, the CMS costing tool allows an end user/owner to update or change or adjust the inputted business-technical variables, the priority levels or ratings and goals to develop an alternate optimal configuration with an alternate set of cost estimates, hence supporting an end user's or owner's decision analysis needs. The decision and sensitivity analysis tool or component 310 processes the business-technical input data or variables against facts or data (such as labor metrics to perform a particular task using a specific tool-set) and business rules stored in the knowledge management system component 306 and further uses functions and formulas encapsulated within the cost analysis modeling component 308 for calculating the operational costs for the optimal configuration determined based on a given set of end user provided requirements. The cost analysis modeling component 308, in an embodiment, includes functions and formulas to estimate the CMS operation's costs. For instance, let f(x)=up-front setup cost of implementing a capacity management service (referred to herein as ‘transition’ costs), which are based on a given set of business-technical variables, whereas, let f(y)=cost of managing the application or operation in a CMS environment over time or the life cycle of the application, but excluding the transition costs (referred to herein as ‘steady state’ costs), which are based on a given set of business/technical variables. As such, the estimated proposal costs or operational costs to be incurred by an owner or end user for undertaking or implementing the application in the CMS environment for the life cycle of the application are estimated by f(z), where f(z)=f(x)+f(y). In an embodiment, the cost analysis modeling component 308 includes algorithms for calculating both f(x) and f(y) to produce f(z) based on a given set of user input regarding business and/or technical variables, and the facts and/or business rules entered in the knowledge management system component.

In an embodiment, the decision and sensitivity analysis component or tool 310 of the CMS costing tool 304 utilizes non-monotonic reasoning, such as, an Assumptions Based Truth Maintenance System (ATMS) to develop cost estimates based on available information from the knowledge management system component or expert system 306, and as new or contradictory information becomes available, the Capacity Management Services (CMS) costing tool is capable of backtracking and retracting the set of assertions, which were used to build its initial configuration or solution, and then developing a new solution based on the newly discovered evidence. In an embodiment, the decision and sensitivity analysis component or tool 310 establishes an overall goal and criteria for decision making based on the end user's/owner's requirements data. It then creates a decision hierarchy based on all known criteria and identifies the various alternatives based on its interaction with other sub-components of the CMS costing tool 304. In an embodiment, the decision and sensitivity analysis component or tool 310 calculates all decision sub-paths within each alternative to compute the lowest cost alternative configuration that meets required goals and criteria. The latter computation is achieved based on an owner's or end user's criteria, facts, data, and/or business rules obtained from the knowledge management system component 306, and the computations performed by the cost analysis modeling component 308.

Once the user changes the requirements criteria by changing any of the values for the technical and/or business variables previously provided, or if any of the previously asserted facts are invalidated by new facts, this component re-computes the cost estimate and provides a new configuration or solution to the user. Accordingly, with all the business rules and data in the knowledge management system component 306, the decision and sensitivity analysis component or tool 310 processes the data and rules associated with various disciplines in parallel, where any interdependency can be resolved instantly, and opportunities in various fields can be associated and explored thoroughly to achieve the optimal configuration or solution effectively. This parallelism not only allows bypassing certain processes that Subject Matter Experts (SME) in various disciplines would need to go through, but also allows securing the opportunities that a decision maker (end user/owner) might otherwise miss. Accordingly, all the interdependencies among infrastructure, application, facility, and business requirements are readily identified and associated seamlessly in parallel, so that the right configuration and its cost is available right after the owner finishes inputting the data. Further, as an owner tunes the priority ratings on various requirements, different options can be proposed with different associated costs, which helps both a service provider and a customer approach the solution from different perspectives. The CMS costing tool 304 provides an opportunity that otherwise would be missed if the rules and data from all the disciplines are not associated together, as a group of SMEs from various disciplines would not necessarily have all the pertinent data in order to thoroughly and systematically go through a what-if analysis and to consider all related data and rules synchronously.

In yet another embodiment, the invention provides a computer program product for determining an optimal configuration and associated operational costs for implementing a capacity management service. The computer program product includes a computer readable or computer-usable medium, which provides program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. Preferably, the computer storage medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Further, preferably, network medium can include of transmission devices on a network, such as, cables, routers, switches and/or network adapter cards.

Preferably, the computer program product is in a form accessible from the computer-usable or computer-readable medium, which provides program codes or instructions for use by or in connection with a computer or any instruction execution system. For the purposes of this description, a computer-usable or computer readable medium can be any apparatus that can contain, store, communicate, propagate, or transport the codes or instructions for use by or in connection with the instruction execution system, apparatus, or device. Preferably, the medium can include an electronic, magnetic, optical, electromagnetic, infrared, or semiconductor system (or apparatus or device) or a propagation medium. More preferably, the computer-readable medium can include a semiconductor or solid state memory, magnetic tape, a removable computer diskette, a random access memory (RAM), a read-only memory (ROM), a rigid magnetic disk and an optical disk. Further, examples of optical disks include compact disc-read only memory (CD-ROM), compact disc-read/write (CD-R/W) and digital versatile/video disc (DVD). The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The computer program product further comprises first program instructions to store input data into an expert system or a knowledge management system, the input data including a plurality of business-technical variables, factual data and business rules and second program instructions to assign a priority rating for one or more of the plurality of business-technical variables based on a set of business-technical factors. The computer program product further comprises third program instructions to determine an optimal configuration for implementing a capacity management service based on the input data stored and to determine associated operational costs for the optimal configuration determined based on the input data stored. In an embodiment, the computer program product further comprises fourth program instructions to provide reports to an end user detailing the optimal configuration determined and the corresponding operational costs determined. In an embodiment, the first program instructions comprise instructions to update factual data and business rules stored in the expert system and wherein the first program instructions comprise instructions to update one or more of the plurality of business-technical variables stored in the expert system. In an embodiment, the second program instructions comprise instructions to harmonize the priority rating assigned for the one or more of the plurality of business-technical variables in order to minimize any inconsistencies among the priority rating assigned for the one or more of the plurality of business-technical variables. In an embodiment, the third program instructions comprise instructions to re-determine an alternate optimal configuration and to re-calculate alternate operational costs for implementing the capacity management service based on any updated factual data and business rules and based on any harmonization of the priority rating for the one or more of the plurality of business-technical variables. In an embodiment, each of the first, second, third and fourth program instructions are stored on the computer readable medium. In an embodiment, the plurality of business-technical input data comprises at least one of current server CPU, current memory, current disk storage, current network interface configuration, current test environment, current production environment, minimal server CPU, optimal server CPU, minimal memory, optimal memory, minimal disk storage, optimal disk storage, minimal network interface configuration, optimal network interface configuration, application software configuration on a server, middleware package configuration on the server, system software configuration on the server, version, release and license type for operating system on the server, version, release and license type for each application software package, version, release and license type for each middleware package, version, release and license type for each system software package, anticipated application usage peak hours, anticipated application usage peak days, anticipated application usage special pattern, anticipated application usage peak to average ratio of application usage, criticality of application, population of users, location of users, type of network connection used by users to access the application, anticipated growth of application usage at different times, location of data center where server will be placed, type of service offerings to be used, type of infrastructure models that application will use, desired date that infrastructure needs to be in production, and desired formats for reports and wherein the set of business-technical factors for establishing the priority level comprises at least one of cost, performance, network bandwidth, length of equipment lease streams, license costs, transaction volumes for each application, input/output requirements, CPU and processing requirements, floor space requirements, power requirements, server consolidation requirements, and ability to effectively execute an application.

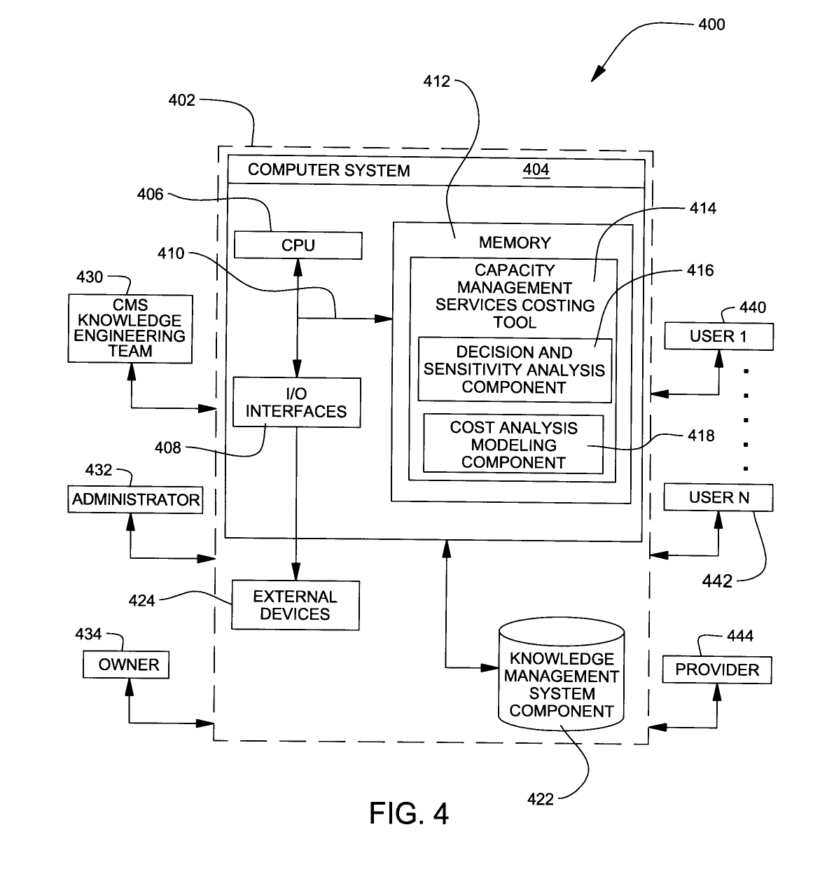

Referring now to FIG. 4, there is illustrated a system 400 for determining an optimal configuration and associated operational costs for implementing a capacity management service, according to the present invention. As depicted, system 400 includes a computer infrastructure 402, which is intended to represent any type of computer architecture that is maintained in a secure environment (i.e., for which access control is enforced). As shown, infrastructure 402 includes a computer system 404 that typically represents a server or the like. It should be understood, however, that although not shown, other hardware and software components (e.g., additional computer systems, such as, application servers, administrative servers, routers, firewalls, etc.) could be included in infrastructure 402.

In general, an owner 434 interfaces with infrastructure 402 for entering or inputting business-technical factors into the Capacity Management Services (CMS) costing tool 414 deployed or installed on the computer system or server 404 in order to determine an optimal configuration and associated operational costs for implementing a capacity management service, such as operating a data call center. Similarly, one or more user 1 (reference numeral 440) and all the other users, including user N (reference numeral 442) can interface with infrastructure 402 for accessing the Capacity Management Services (CMS) costing tool for determining an optimal configuration and associated operational costs for implementing a capacity management service. Furthermore, the Capacity Management Services (CMS) knowledge engineering team 430 can also interface with computer system 404 for inputting or entering the factual data and/or business rules associated with determining an optimal configuration and costs for implementing a capacity management service. In general, the parties could access infrastructure 402 directly, or over a network via interfaces (e.g., client web browsers) loaded on computerized devices (e.g., personal computers, laptops, handheld devices, etc.). In the case of the latter, the network can be any type of network such as the Internet or can be any other network, such as, a local area network (LAN), a wide area network (WAN), a virtual private network (VPN), etc. In any event, communication with infrastructure 402 could occur via a direct hardwired connection (e.g., serial port), or via an addressable connection that may utilize any combination of wire line and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, the parties could utilize an Internet service provider to establish connectivity to infrastructure 402. It should be understood that under the present invention, infrastructure 402 could be owned and/or operated by a party such as provider 444, or by an independent entity. Regardless, use of infrastructure 402 and the teachings described herein could be offered to the parties on a subscription or fee-basis. In either scenario, an administrator 432 could support and configure infrastructure 402.

Computer system or server 404 is shown to include a CPU (hereinafter “processing unit 406”), a memory 412, a bus 410, and input/output (I/O) interfaces 408. Further, computer system 400 is shown in communication with external I/O devices/resources 424 and storage system 422. In an embodiment as shown, the storage system 422 includes a knowledge management system component that is configured to store factual data and business rules associated with determining an optimal configuration and operational costs for implementing a capacity management service. Further, the storage system 422, in an embodiment, is configured to store the plurality of business-technical input data received from the end user. In general, processing unit 406 executes computer program codes, such as the Capacity Management Services (CMS) costing tool 414, which includes the decision and sensitivity analysis component 416 and the cost analysis modeling component 418. While executing the Capacity Management Services (CMS) costing tool 414, the processing unit 406 can read and/or write data, to/from memory 412, storage system 422, and/or I/O interfaces 408. Bus 410 provides a communication link between each of the components in computer system 400. External devices 424 can include any devices (e.g., keyboard, pointing device, display, etc.) that enable a user to interact with computer system 400 and/or any devices (e.g., network card, modem, etc.) that enable computer system 400 to communicate with one or more other computing devices.

Computer infrastructure 402 is only illustrative of various types of computer infrastructures for implementing the invention. For example, in one embodiment, computer infrastructure 402 includes two or more computing devices (e.g., a server cluster) that communicate over a network to perform the various process steps of the invention. Moreover, computer system 400 is only representative of various possible computer systems that can include numerous combinations of hardware. To this extent, in other embodiments, computer system 400 can include any specific purpose computing article of manufacture comprising hardware and/or computer program code for performing specific functions, any computing article of manufacture that includes a combination of specific purpose and general purpose hardware/software, or the like. In each case, the program code and hardware can be created using standard programming and engineering techniques, respectively. Moreover, processing unit 406 may include a single processing unit, or be distributed across one or more processing units in one or more locations, e.g., on a client and server. Similarly, memory 412 and/or storage system 422 can include any combination of various types of data storage and/or transmission media that reside at one or more physical locations. Further, I/O interfaces 408 can include any system for exchanging information with one or more external devices 424. Still further, it is understood that one or more additional components (e.g., system software, math co-processing unit, etc., not shown in FIG. 4) can be included in computer system 400. Similarly, it is understood that the one or more external devices 424 (e.g., a display) and/or storage system(s) 422 could be contained within computer system 404, and not externally as shown.

Storage system 422 can be any type of system (e.g., a database) capable of storing information or data, such as a knowledge management system component that provides a knowledge repository under the present invention. To this extent, storage system 422 could include one or more storage devices, such as a magnetic disk drive or an optical disk drive. In another embodiment, storage system 422 includes data distributed across, for example, a local area network (LAN), wide area network (WAN) or a storage area network (SAN) (not shown). Although not shown, additional components, such as cache memory, communication systems, system software, etc., may be incorporated into computer system 400.

Accordingly, in an embodiment, the Capacity Management Services (CMS) costing tool provides a comprehensive solution with cost estimates utilizing any tool-set chosen by the owner from among several commercial server sizing and projection tools and several commercial CMS systems management infrastructures, (including enterprise solutions, suite solutions and point solutions) versus a single vendor's tool specific solutions, which may not be the most cost effective, but may allow for flexibility in choosing the most cost effective tool-set for each distinct phase of the CMS life-cycle. Further, the Capacity Management Services (CMS) costing tool provides a comprehensive solution encompassing business rules, facts and constraints of all aspects of architectures, (including infrastructure, operations, application, storage, etc.) that are specific to the CMS implementation and life-cycle management, based on lessons perhaps learned from a previous CMS life-cycle management operation, while utilizing well-recognized CMS environment implementation and life-cycle management operation's methodology. Moreover, the Capacity Management Services (CMS) costing tool provides novice owners and expert owners alike, the ability to produce comprehensive costs estimates for the CMS environment implementation and life-cycle management operation in an automated manner, within a very short period of time, and without having to spend several thousands of dollars on hiring a subcontractor to perform the same work. Furthermore, the Capacity Management Services (CMS) costing tool provides owners an immediate Return on Investment (ROI). It allows the owners to obtain the cost estimate results immediately to make immediate decisions. It also allows owners to perform cost sensitivity (what-if) analysis with respect to the proposed estimate by altering the values of the technical and business variables, to get an immediate result back, and therefore allows them to quickly generate several cost estimates/proposals based on different scenarios, multi-vendor tool-set choices, etc. in order to make better management decisions. Additionally, given that the knowledge management system component of the Capacity Management Services (CMS) costing tool is periodically updated with state of the art technical information and business rules, facts and constraints that are specific to the CMS implementation and life-cycle management operation, an owner and/or end user is able to use the tool for extended periods.

The foregoing descriptions of specific embodiments of the present invention have been presented for the purpose of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method of determining a configuration for a computer system, the method comprising the steps of:
a computer receiving user selection of a plurality of different priority levels for a respective plurality of different computer system specifications to indicate a plurality of different respective importances of meeting the respective different computer system specifications in the configuration of the computer system;
the computer changing the user-selected priority level for one of the plurality of computer system specifications to reduce an inconsistency between the user-selected priority level for the one computer system specification and the user-selected priority level for another of the plurality of computer system specifications; and
the computer determining and making an electronic record of a configuration for the computer system based in part on the one changed user-selected priority level and the other user-selected priority levels.

2. The method of claim 1, further comprising the step of the computer determining and making an electronic record of an operational cost for the computer system, based in part on the one changed user-selected priority level and the other user-selected priority levels.

3. The method of claim 1 wherein the computer system specifications include minimal CPU, optimal CPU, minimal memory and optimal memory, of the computer system.

4. The method of claim 3 wherein the computer system specifications also include at least two of the following: anticipated usage peak hours for an application, anticipated usage peak days for an application, anticipated usage special pattern for an application, and anticipated usage peak to average ratio of usage for an application.

5. The method of claim 3 wherein the computer system specifications also include minimal network interface configuration and optimal network interface configuration, of the computer system.

6. The method of claim 5 wherein the computer system specifications include type of network connection used by users to access an application.

7. The method of claim 1 wherein the computer system specifications include application software, middleware, system software, and operating system of the computer system.

8. The method of claim 1 wherein there are multiple, different user-selectable priority levels for each of the computer system specifications.

9. A computer program product comprising a computer-readable tangible storage device(s) and computer-readable program instructions stored on the computer-readable tangible storage device(s) to determine a configuration for a computer system, the computer-readable program instructions, when executed by a CPU:
receive user selection of a plurality of different priority levels for a respective plurality of different computer system specifications to indicate a plurality of different respective importances of meeting the respective different computer system specifications in the configuration of the computer system;
change the user-selected priority level for one of the plurality of computer system specifications to reduce an inconsistency between the user-selected priority level for the one computer system specification and the user-selected priority level for another of the plurality of computer system specifications; and
determine and make an electronic record of a configuration for the computer system based in part on the one changed user-selected priority level and the other user-selected priority levels.

10. The computer program product of claim 9, wherein the computer-readable program instructions, when executed by a CPU also determine and make an electronic record of an operational cost for the computer system, based in part on the one changed user-selected priority level and the other user-selected priority levels.

11. The computer program product of claim 9 wherein the computer system specifications include minimal CPU, optimal CPU, minimal memory and optimal memory, of the computer system.

12. The computer program product of claim 11 wherein the computer system specifications also include at least two of the following: anticipated usage peak hours for an application, anticipated usage peak days for an application, anticipated usage special pattern for an application, and anticipated usage peak to average ratio of usage for an application.

13. The computer program product of claim 11 wherein the computer system specifications also include minimal network interface configuration and optimal network interface configuration, of the computer system.

14. The computer program product of claim 13 wherein the computer system specifications include type of network connection used by users to access an application.

15. The computer program product of claim 9 wherein the computer system specifications include application software, middleware, system software, and operating system of the computer system.

16. The computer program product of claim 9 wherein there are multiple, different user-selectable priority levels for each of the computer system specifications.

17. A computer system for determining a configuration for a computer, the computer system comprising:
a CPU, a computer-readable, tangible storage device and a computer-readable memory;
program instructions, stored on the storage device for execution by the CPU via the memory, to receive user selection of a plurality of different priority levels for a respective plurality of different computer system specifications to indicate a plurality of different respective importances of meeting the respective different computer system specifications in the configuration of the computer system;
program instructions, stored on the storage device for execution by the CPU via the memory, to change the user-selected priority level for one of the plurality of computer system specifications to reduce an inconsistency between the user-selected priority level for the one computer system specification and the user-selected priority level for another of the plurality of computer system specifications; and
program instructions, stored on the storage device for execution by the CPU via the memory, to determine and make an electronic record of a configuration for the computer system based in part on the one changed user-selected priority level and the other user-selected priority levels.

18. The computer system of claim 17, further comprising program instructions, stored on the storage device for execution by the CPU via the memory, to determine and make an electronic record of an operational cost for the computer system, based in part on the one changed user-selected priority level and the other user-selected priority levels.

19. The computer system of claim 17 wherein the computer system specifications include minimal CPU, optimal CPU, minimal memory and optimal memory, of the computer system.

20. The computer system of claim 19 wherein the computer system specifications also include at least two of the following: anticipated usage peak hours for an application, anticipated usage peak days for an application, anticipated usage special pattern for an application, and anticipated usage peak to average ratio of usage for an application.

21. The computer system of claim 19 wherein the computer system specifications also include minimal network interface configuration and optimal network interface configuration, of the computer system.

22. The computer system of claim 21 wherein the computer system specifications include type of network connection used by users to access an application.

23. The computer system of claim 17 wherein the computer system specifications include application software, middleware, system software, and operating system of the computer system.

24. The computer system of claim 17 wherein there are multiple, different user-selectable priority levels for each of the computer system specifications.
